(19) United States
(12) Patent Application Publication
(10) Pub. No.: US 2015/0055304 A1
(43) Pub. Date: Feb. 26, 2015

(54) ELECTRONIC DEVICE

(71) Applicant: Wistron Corporation, New Taipei City (TW)

(72) Inventor: Ching-Huei Chang, New Taipei City (TW)

(73) Assignee: Wistron Corporation, New Taipei City (TW)

(21) Appl. No.: 14/040,734

(22) Filed: Sep. 30, 2013

(30) Foreign Application Priority Data
Aug. 26, 2013 (TW) 102130459

(51) Int. Cl. G06F 1/18

(52) U.S. Cl. CPC G06F 1/182
USPC 361/728

(57) ABSTRACT

An electronic device including a main chassis, an electronic module and an electromagnetic interference shielding structure is provided. The electronic module is disposed in the main chassis. The electromagnetic interference shielding structure includes a conductive plate and a plurality of conductive elastic pieces. The conductive plate is assembled to the main chassis. The conductive elastic pieces are connected to the conductive plate and arranged along a first direction. Each of the conductive elastic pieces extends along a second direction perpendicular to the first direction. Each of the conductive elastic pieces has an arc contacting surface, and the arc contacting surface of at least one of the conductive elastic pieces contacts the electronic module. An electromagnetic wave emitted from the electronic module passes through the corresponding conductive elastic piece and the conductive plate in sequence to be transmitted to the main chassis.

### CROSS-REFERENCE TO RELATED APPLICATION

This application claims the priority benefit of Taiwan application serial no. 102130459, filed on Aug. 26, 2013. The entirety of the above-mentioned patent application is hereby incorporated by reference herein and made a part of this specification.

### BACKGROUND OF THE INVENTION

1. Field of the Invention

The invention relates to an electronic device, and more particularly, to an electronic device having an electromagnetic interference (EMI) shielding structure.

2. Description of Related Art

With the rapid development of technology, personal computers have been widely applied in daily life or in the working places. A common personal computer includes a desktop computer and a notebook computer. An electromagnetic interference shielding structure is usually disposed at a chassis of the personal computer in order to prevent an electromagnetic wave emitted from electronic members inside the personal computer from being transmitted to the main board to influence normal operations of main board. The electromagnetic interference shielding structure includes conductive elastic pieces configured to contact the electronic members and guide the electromagnetic wave emitted from electronic members to the chassis, so as to achieve an effectiveness of electromagnetic interference shielding. The conductive elastic pieces can be formed by performing a stamping process to a conductive plate. More specifically, a plurality of conductive elastic pieces and a plurality of riveting joints can be stamped on a strip-shape conductive plate (e.g., a stainless steel plate), and the conductive plate can be cut to obtain the conductive plate with appropriate amount of the conductive elastic pieces according to an amount of the conductive elastic pieces required, such that the conductive plate can be riveted on the chassis of the personal computer through the riveting joints.

Generally, the conductive elastic pieces are arranged in sequence along a long direction of the strip-shape conductive plate. In conventional design of the conductive plate and the conductive elastic pieces, an extending direction of each conductive elastic piece is parallel to the arranging direction of each conductive elastic piece, and a length of each conductive plate is relatively longer on the extending direction thereof. Accordingly, the conductive plate requires a longer length for stamping sufficient amount of the conductive elastic pieces, which leads to wasting of material. Furthermore, in conventional design of the conductive plate and the conductive elastic pieces, only one of the riveting joints is provided between two adjacent conductive elastic pieces. As a result, an end of the conductive plate remained after cutting is lack of riveting joint for further utilization, which also leads to wasting of material.

### SUMMARY OF THE INVENTION

The invention is directed to an electronic device capable of saving material used for an electromagnetic interference shielding structure.

The electronic device of the invention includes a main chassis, an electronic module and an electromagnetic interference shielding structure. The electronic module is disposed in the main chassis. The electromagnetic interference shielding structure includes a conductive plate and a plurality of conductive elastic pieces. The conductive plate is assembled to the main chassis. The conductive elastic pieces are connected to the conductive plate and arranged along a first direction. Each of the conductive elastic pieces extends along a second direction perpendicular to the first direction. Each of the conductive elastic pieces has an arc contacting surface, and the arc contacting surface of at least one of the conductive elastic pieces contacts the electronic module. An electromagnetic wave emitted from the electronic module passes through the corresponding conductive elastic piece and the conductive plate in sequence to be transmitted to the main chassis.

In an embodiment of the present invention, the electronic module includes a metallic chassis and an electronic member. An arc contacting surface of at least one of the conductive elastic pieces contacts the metallic chassis. The electronic member is disposed in the metallic chassis.

In an embodiment of the invention, the conductive plate has a plurality of riveting joints, two of the riveting joints are provided between two adjacent conductive plates, and the conductive plate is riveted to the main chassis through the riveting joints.

In an embodiment of the invention, a length of each of the conductive elastic pieces along the first direction is less than a length of each of the conductive elastic pieces along the second direction.

In an embodiment of the invention, the conductive plate has a plurality of openings, the conductive elastic pieces are respectively located in the openings, and each of the conductive elastic pieces is extended from an inner edge of the corresponding opening.

In an embodiment of the invention, a length of each of the openings along the first direction is less than a length of each of the openings along the second direction.

In an embodiment of the present invention, the electromagnetic interference shielding structure is formed by a stamping process.

In an embodiment of the present invention, the main chassis has a plurality of holes, the conductive plate is assembled to a side of the main chassis, the electronic module is disposed at another side of the main chassis, each of the arc contacting surfaces is located at an end of the corresponding conductive elastic piece, and the ends of the conductive elastic pieces respectively protrude to the another side of the main chassis through the holes.

In an embodiment of the present invention, each of the conductive elastic pieces bends towards the electronic module to be inclined to the conductive plate.

Based on above, in the electromagnetic interference shielding structure of the invention, the extending direction (i.e., said second direction) of each of the conductive elastic pieces is perpendicular to the arranging direction (i.e., said first direction) of the conductive elastic pieces. Thus, in case the conductive elastic piece has the longer length on the extending direction thereof, the size of each of the conductive elastic pieces along the long direction of the conductive plate can be reduced, so as to save materials used for the conductive plate.

To make the above features and advantages of the disclosure more comprehensible, several embodiments accompanied with drawings are described in detail as follows.

### BRIEF DESCRIPTION OF THE DRAWINGS

FIG. 1 is a three dimensional diagram illustrating partial members of an electronic device according to an embodiment of the invention.

FIG. 2 is a partial sectional diagram of the electric device depicted in FIG. 1.

FIG. 3 is a partial three dimensional diagram illustrating the electronic device depicted in FIG. 1 from another perspective.

FIG. 4 is a partial three dimensional diagram illustrating the electromagnetic interference shielding structure depicted in FIG. 1.

FIG. 5 is a partial schematic diagram illustrating the electromagnetic interference shielding structure depicted in FIG. 4.

FIG. 6 is a schematic diagram illustrating cutting of the conductive plate.

### DESCRIPTION OF THE EMBODIMENTS

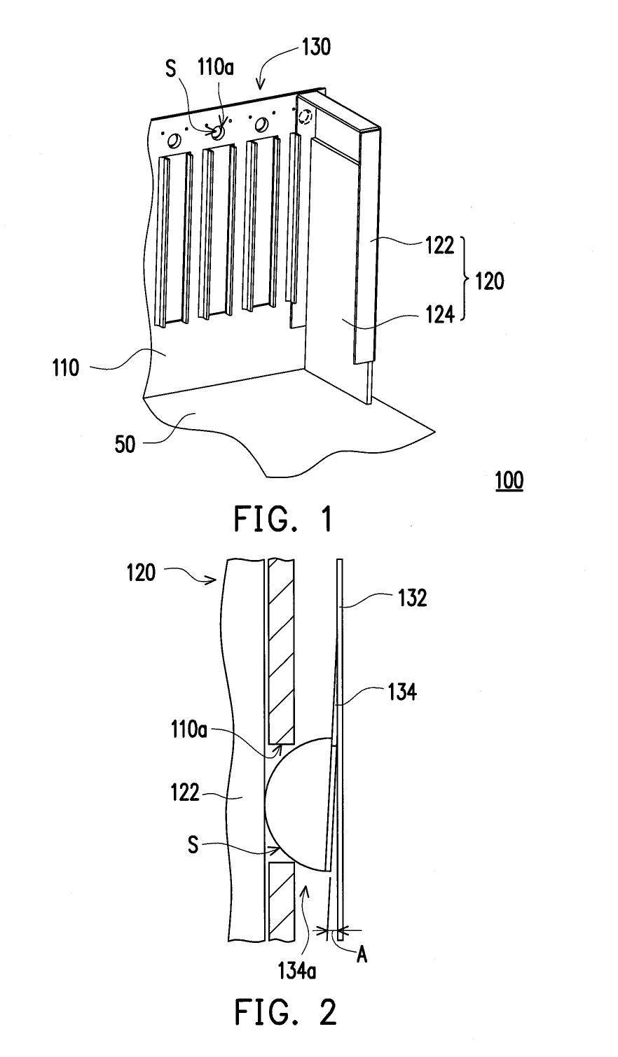

FIG. 1 is a three dimensional diagram illustrating partial members of an electronic device according to an embodiment of the invention. Referring to FIG. 1, an electronic device 100 of the present embodiment is, for example, a host of a desktop computer, which includes a main chassis 110 and an electronic module 120. The main chassis 110 is, for example, a casing of said host, and a main board 50 is disposed in the main chassis 110. The electronic module 120 is disposed in the main chassis 110 and includes a metallic chassis 122 and an electronic member 124. The electronic member 124 is, for example, an adapter, disposed at the metallic chassis 122 and inserted to the main board 50.

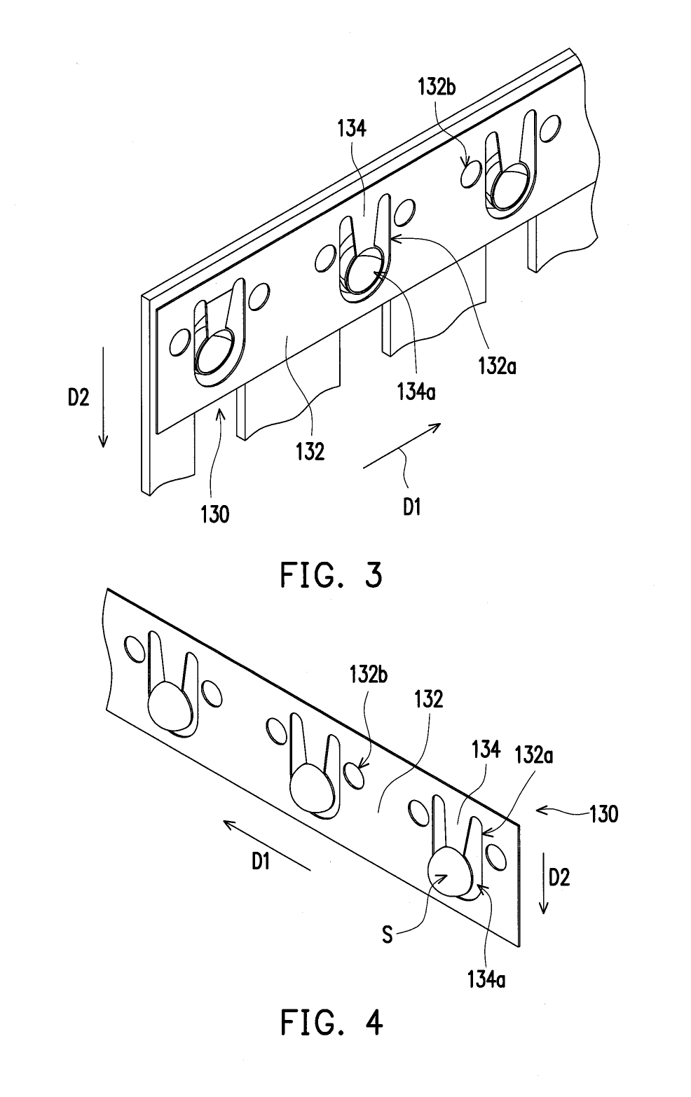

FIG. 2 is a partial sectional diagram of the electric device depicted in FIG. 1. FIG. 3 is a partial three dimensional diagram illustrating the electronic device depicted in FIG. 1 from another perspective. FIG. 4 is a partial three dimensional diagram illustrating the electromagnetic interference shielding structure depicted in FIG. 1. Referring FIG. 2 through FIG. 4, the electronic device 100 further includes an electromagnetic interference shielding structure 130. The electromagnetic interference shielding structure 130 includes a conductive plate 132 and a plurality of conductive elastic pieces 134 connected to the conductive plate 132. The conductive plate 132 is assembled to a side of the main chassis 110, and the electronic module 120 is disposed at another side of the main chassis 110. An end 134a of each of the conductive elastic pieces 134 has an arc contacting surface S. The main chassis 110 has a plurality of holes 110a, and the ends 134a of the conductive elastic pieces 134 respectively protrude to the another side of the main chassis 110 through the holes 110a. Accordingly, the arc contacting surface S of at least one of the conductive elastic pieces 134 contacts the metallic chassis 122 of the electronic module 120 through an elastic force of the conductive elastic piece 134 as shown in FIG. 2. As a result, an electromagnetic wave emitted from the electronic member 124 of the electronic module 120 can pass through the corresponding conductive elastic piece 134 and the conductive plate 132 in sequence to be transmitted to the main chassis 110, so as to prevent the electromagnetic wave from being transmitted to the main board 50 to influence normal operations of the main board 50. In FIG. 1, other conductive elastic pieces 134 not contacting the electronic module 120 can be used to contact other electronic members in the electronic device 100 for performing an electromagnetic interference shielding thereto.

In the present embodiment, the conductive plate 132 has a plurality of riveting joints 132b as shown in FIG. 3 and FIG. 4, and the conductive plate 132 is riveted to the main chassis 110 depicted in FIG. 1 through the riveting joints 132b, for example. In addition, the conductive elastic pieces 134 is designed to bend towards the electronic module 120 to be inclined to the conductive plate 132 as shown in FIG. 2, so that the conductive elastic pieces 134 can be sure to contact the metallic chassis 122 of the electronic module 120, so as to achieve an effectiveness of the electromagnetic interference shielding. An inclined angle A between the conductive elastic piece 134 and the conductive plate 132 is, for example, 5 degrees or other appropriate angles, and the invention is not limited thereto.

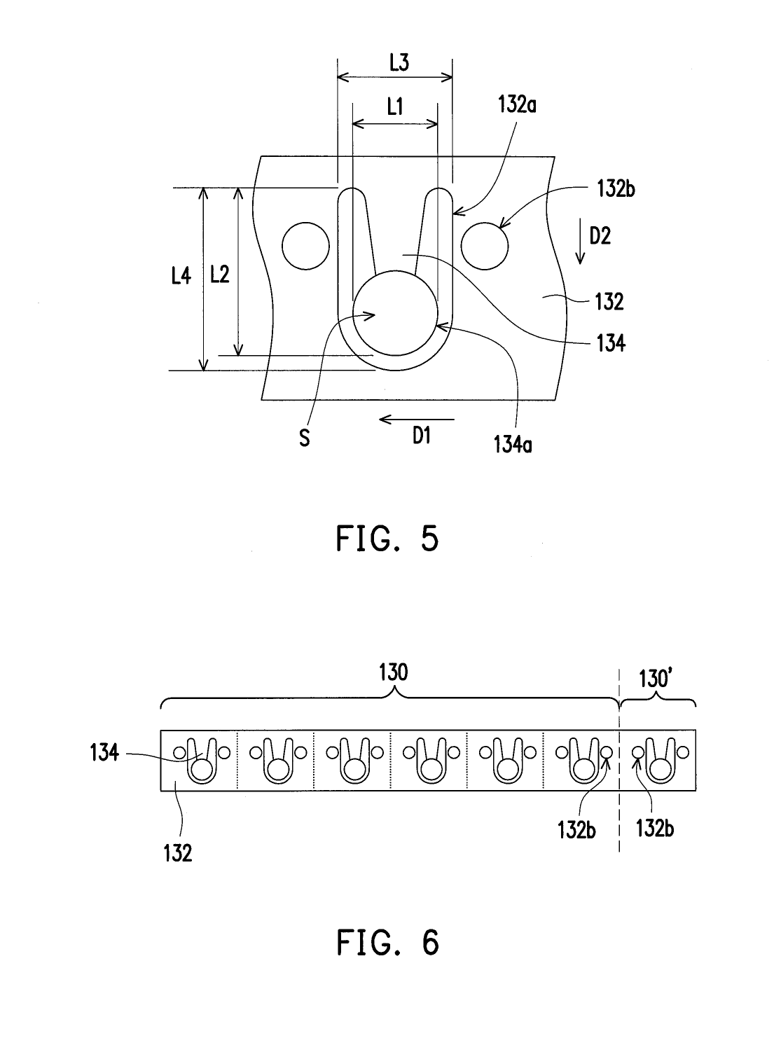

FIG. 5 is a partial schematic diagram illustrating the electromagnetic interference shielding structure depicted in FIG. 4. Referring to FIGS. 3 through 5, the conductive elastic pieces 134 are arranged along a first direction D1, in which a length L1 of each of the conductive elastic pieces 134 along the first direction D1 is less than a length L2 of each of the conductive elastic pieces 134 along a second direction D2 being perpendicular to the first direction D1. Further, the conductive plate 132 has a plurality of openings 132a, the conductive elastic pieces 134 are respectively located in the openings 132a, and each of the conductive elastic pieces 134 is extended from an inner edge of the corresponding opening 132a. Since the length L1 of each of the conductive elastic pieces 134 along the first direction D1 is less than the length L2 of each of the conductive elastic pieces 134 along the second direction D2 as described above, a length L3 of each of the openings 132a along the first direction D1 is correspondingly less than a length L4 of each of the openings 132a along the second direction D2. In other words, each of the conductive elastic pieces 134 has a longer length (i.e., the length L2) on an extending direction thereof, and each of the opening 132a also has a longer length (i.e., the length L4) on the extending direction of each of the conductive elastic pieces 134.

In the present embodiment, each of the conductive elastic pieces 134 is designed to extend along the second direction D2 being perpendicular to a long direction of the conductive plate 132 instead of extending along the first direction D1 being parallel to the long direction of the conductive plate 132. Based on above, in case each of the conductive elastic pieces 134 and each of the openings 132a both have the longer length on the extending direction of the conductive elastic pieces 134, sizes of each of the conductive elastic pieces 134 and each of the openings 132a along the long direction of the conductive plate 132 can be reduced, so as to save materials used for the conductive plate 132.

The electromagnetic interference shielding structure 130 is formed by a stamping process, for example. More specifically, after the conductive elastic pieces 134 and a plurality of riveting joints 132b are formed on the conductive plate 132 by the stamping process, the conductive plate 132 can be cut according to an amount of the conductive elastic pieces 134 required, so as to obtain the conductive plate 132 with appropriate amount of the conductive elastic pieces 134. As shown in FIG. 3 and FIG. 4, in the present embodiment, two riveting joints 132b are provided between two adjacent conductive elastic pieces 134, and thus a problem in which the end of the conductive plate 132 remained after cutting being lack of riveting joint for further utilization is resolved. Details regarding the same are described below with reference to FIG. 6.

FIG. 6 is a schematic diagram illustrating cutting of the conductive plate. If the conductive plate 132 after the stamping process has seven conductive elastic pieces 134 as shown in FIG. 6 and the amount of the conductive elastic pieces 134 required by the electronic device 100 shown in FIG. 1 is six, then the conductive elastic pieces 134 need to be cut in order to obtain the electromagnetic interference shielding structure 130 that meets said requirement. Another electromagnetic interference shielding structure 130′ is composed by the conductive plate 132 remained and single one of the conductive elastic pieces 134. Since two of the riveting joints 132b are provided between the two adjacent conductive elastic pieces 134, in the electromagnetic interference shielding structure 130′ remained after the cutting, two sides of the conductive elastic pieces 134 are both provided with the riveting joints 132b, so that an assembly can be performed to resolve wasting of the materials.

In summary, in the electromagnetic interference shielding structure of the invention, the extending direction (i.e., said second direction) of each of the conductive elastic pieces is perpendicular to the arranging direction (i.e., said first direction) of the conductive elastic pieces. Thus, in case the conductive elastic piece has the longer length on the extending direction thereof, the size of each of the conductive elastic pieces along the long direction of the conductive plate can be reduced, so as to save materials used for the conductive plate. Moreover, with the two riveting joints provided between the two adjacent conductive elastic pieces, the problem in which the end of the conductive plate remained after cutting being lack of riveting joint for further utilization is resolved to further save materials used for the conductive plate.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An electronic device, comprising:
a main chassis;
an electronic module disposed in the main chassis; and
an electromagnetic interference shielding structure comprising:
a conductive plate assembled to the main chassis; and
a plurality of conductive elastic pieces connected to the conductive plate and arranged along a first direction, wherein each of the conductive elastic pieces extends along a second direction perpendicular to the first direction, each of the conductive elastic pieces has an arc contacting surface, the arc contacting surface of at least one of the conductive elastic piece contacts the electronic module, and an electromagnetic wave emitted from the electronic module passes through the corresponding conductive elastic piece and the conductive plate in sequence to be transmitted to the main chassis.

2. The electronic device of claim 1, wherein the electronic module comprises:
a metallic chassis, the arc contacting surface of at least one of the conductive elastic pieces contacts the metallic chassis; and
an electronic member disposed in the metallic chassis.

3. The electronic device of claim 1, wherein the conductive plate has a plurality of riveting joints, two of the riveting joints are provided between two adjacent conductive plates, and the conductive plate is riveted to the main chassis through the riveting joints.

4. The electronic device of claim 1, wherein a length of each of the conductive elastic pieces along the first direction is less than a length of each of the conductive elastic pieces along the second direction.

5. The electronic device of claim 1, wherein the conductive plate has a plurality of openings, the conductive elastic pieces are respectively located in the openings, and each of the conductive elastic pieces is extended from an inner edge of the corresponding opening.

6. The electronic device of claim 5, wherein a length of each of the openings along the first direction is less than a length of each of the openings along the second direction.

7. The electronic device of claim 1, wherein the electromagnetic interference shielding structure is formed by a stamping process.

8. The electronic device of claim 1, wherein the main chassis has a plurality of holes, the conductive plate is assembled to a side of the main chassis, the electronic module is disposed at another side of the main chassis, each of the arc contacting surfaces is located at an end of the corresponding conductive elastic piece, and the ends of the conductive elastic pieces respectively protrude to the another side of the main chassis through the holes.

9. The electronic device of claim 1, wherein each of the conductive elastic pieces bends towards the electronic module to be inclined to the conductive plate.
